(19) United States
(12) Patent Application Publication
(10) Pub. No.: US 2013/0166362 A1
(43) Pub. Date: Jun. 27, 2013

(54) System And Method For Promotional Discounted Aggregated Purchasing

(71) Applicant: BAG THAT TRADING LIMITED, Milton Keynes (GB)

(72) Inventor: Andrew SUTTON, Thornborough (GB)

(73) Assignee: BAG THAT TRADING LIMITED, Milton Keynes (GB)

(21) Appl. No.: 13/629,078

(22) Filed: Sep. 27, 2012

Related U.S. Application Data
(60) Provisional application No. 61/543,050, filed on Oct. 4, 2011.

(51) Int. Cl. G06Q 30/02

(52) U.S. Cl. CPC G06Q 30/0223
USPC 705/14.13; 705/14.24

(57) ABSTRACT

A system, method, and computer program product provides discounted aggregated purchasing. A method for promotional discounted aggregated purchasing may include determining a volume discount matrix for a product to be available during a promotional period, accepting bids from a plurality of consumers indicating a price each consumer is willing to pay for the product, placing a hold on payment cards of the consumers who have entered bids, each hold being for the amount of each bid, at a conclusion of the promotional period, determining a price for the product based on a final discount level that is determined based on the received bids and on the determined volume discount matrix, and performing transactions for the product for all consumers who bid an amount greater than or equal to the determined price.

### CROSS-REFERENCE TO RELATED APPLICATIONS

This application claims the benefit of Provisional Application No. 61/543,050, filed Oct. 4, 2011, the contents of which are incorporated herein in their entirety.

### BACKGROUND OF THE INVENTION

1. Field of the Invention

The present invention relates to a system, method, and computer program product for providing discounted aggregated purchasing.

2. Description of the Related Art

In the retail industry, ‘opportunity to purchase’ promotional windows providing consumers with the opportunity to take advantage of discounted pricing over a pre-defined period are a well-known business technique. Within retail, such events are commonplace under a variety of different themes (e.g. January SALES) and it is very usual for people to stall their buying decisions pending the arrival of such an event. In the online environment, sites such as eBay (www.ebay.com), ACHICA (www.achica.com) and Groupon (www.groupon.com) use promotional windows very effectively as a means to focus buyer attention and transaction activity. However, these conventional promotional techniques have a number of drawbacks. For example, typically, they have very limited quantities of product for sale and offer the same discount regardless of the actual volume of product purchased. This limits the ability and/or interest of consumers to participate in such promotions.

A need arises for a technique by which promotional discounted aggregated purchasing may be provided which does not limit the ability and/or interest of consumers to participate in such promotions.

### SUMMARY OF THE INVENTION

A system, method, and computer program product provides discounted aggregated purchasing which does not limit the ability and/or interest of consumers to participate in such promotions. Using this technology, greater discounts may be offered for greater total volumes of product purchased. Consumers are provided with the capability to purchase at the same price even if they have bid at a higher price. The payment card transaction process may include ‘ring fenced’ bids and delayed transactions. The system may provide the capability for consumers to indicate what they might want in future and at what price. Supplier analytics provides the capability to use real time promotion analytics to adjust promotion dynamics in real time in order to drive better outcomes.

For example, a method for promotional discounted aggregated purchasing may comprise determining a volume discount matrix for a product to be available during a promotional period, accepting bids from a plurality of consumers indicating a price each consumer is willing to pay for the product, placing a hold on payment cards of the consumers who have entered bids, each hold being for the amount of each bid, at a conclusion of the promotional period, determining a price for the product based on a final discount level that is determined based on the received bids and on the determined volume discount matrix, and performing transactions for the product for all consumers who bid an amount greater than or equal to the determined price. The volume discount matrix may comprise information indicating a minimum volume of the product that must be purchased in order to obtain a corresponding discount level. The method may further comprise accepting the bids from the consumers without revealing information related to the volume discount matrix to the consumers. The method may further comprise accepting input from consumers relating to products and/or services which the consumers would like to see as future promotions and relating to prices the consumers are willing to pay and aggregating the input from the consumers to determine recommendations for future promotions. The method may further comprise analyzing information relating to the promotional discounted aggregated purchasing in real-time to generate promotion metrics.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram of a process of discounted aggregated purchasing.

FIG. 2 is an exemplary illustration of a volume discount matrix.

FIG. 3 shows an example of a home webpage of the promotional system operator website.

FIG. 4 shows an example of a live promotion page.

FIG. 5 shows an example of a determined final discount level.

FIG. 6 is an exemplary promotion analysis report.

FIG. 7 is an exemplary promotion analysis report including a summary of key promotion metrics.

FIG. 8 is an exemplary chart showing a time log of when bids were made during the promotion and at what level.

FIG. 9 is an exemplary block diagram of a computer system, in which a process of discounted aggregated purchasing may be implemented.

### DETAILED DESCRIPTION OF THE INVENTION

A system, method, and computer program product provides discounted aggregated purchasing which does not limit the ability and/or interest of consumers to participate in such promotions. Using this technology, greater discounts may be offered for greater total volumes of product purchased. Consumers are provided with the capability to purchase at the same price even if they have bid at a higher price. The payment card transaction process may include ‘ring fenced’ bids and delayed transactions. The system may provide the capability for consumers to indicate what they might want in future and at what price. Supplier analytics provides the capability to use real time promotion analytics to adjust promotion dynamics in real time in order to drive better outcomes.

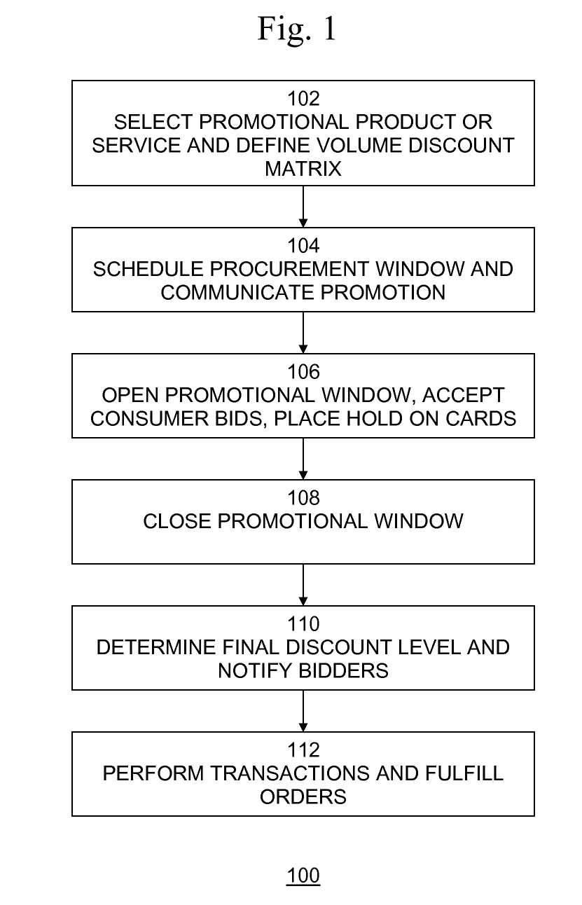

An exemplary flow diagram of a process 100 of discounted aggregated purchasing is shown in FIG. 1. Process 100 begins with step 102 a promotional product or service is selected and a volume discount matrix is defined. Suppliers are contacted and agree on a particular product or service that will form the centre of a time limited promotion. Unlike models that are predicated on low value, locally based service offerings, the model used in the present invention is equally well suited to higher value, consumer products, such as electrical goods (TV's, white goods, etc.), branded fashion items (handbags, watches, clothing, shoes, etc.) , sports equipment (cycles, gym equipment) and potentially, even larger ticket items such as cars or homes. In addition, promotions could encompass service offerings such as event tickets, spa breaks, packaged holidays, flights, etc.

In addition to selecting one or more products or services for a promotion, a pre-promotion volume discount matrix is negotiated with the supplier determining the levels of discount that are available depending upon final volume of sales achieved. Note that this matrix can be adjusted during the promotion based on real time analytics provided. For example, the discount steps may be granular—such as in 1% increments ranging from no discount to the maximum discount available. At this stage, a commission for the promotional system operator is determined as a % of discounted sales price. It is noted that the promotional system operator may include any entity that operates a promotional system.

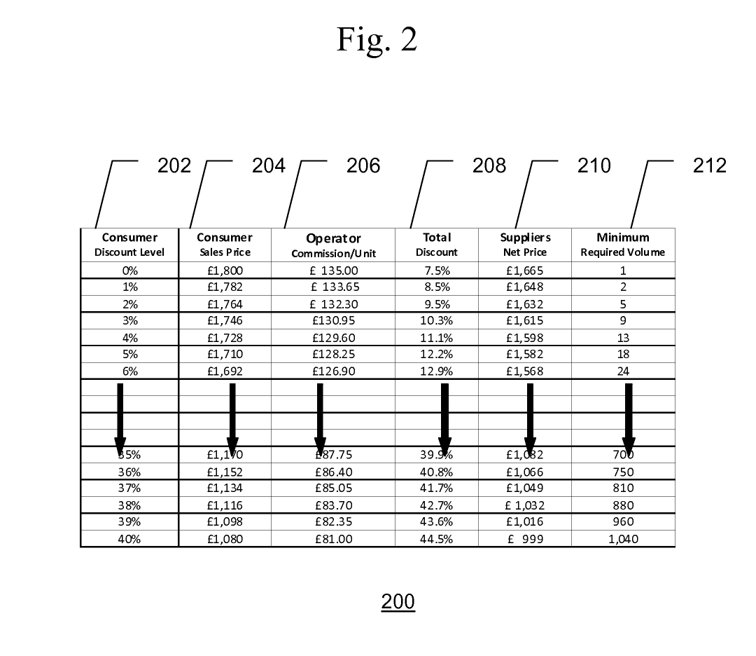

An example of a volume discount matrix 200, including a promotional system operator commission of 7.5% of net sales price, is shown in FIG. 2. Exemplary volume discount matrix 200 may include a plurality of columns, such as consumer discount level column 202, consumer sales price column 204, operator commission/unit column 206, total discount column 208, supplier's net price column 210, and minimum required volume column 212. Consumer discount level column 202 may include a plurality of discount steps, such as in 1% increments ranging from no discount to the maximum discount available. Consumer sales price column 204 may include the sales price charged to the consumer at each discount step in consumer discount level column 202. Operator commission/unit column 206 may include the amount of the operator's commission per unit, at the exemplary value of 7.5% of net sales price. Total discount column 208 may include the total percentage discount from the consumer sales price that is received by the supplier. Supplier's net price column 210 may include the total sales price that is received by the supplier. Minimum required volume column 212 may include the minimum volume of promotional items that must be purchased in order to obtain the corresponding consumer discount level.

Returning to FIG. 1, in step 104, with the volume discount matrix agreed, the promotional system operator works with the supplier to schedule a ‘procurement window’ for the promotional activity. A typical example could be a 3 day window scheduled 4 weeks into the future. Having defined the procurement window, the promotional system operator, in partnership with the supplier, embarks on an intensive 4 week marketing communications plan to broadcast the upcoming promotion far and wide. The promotional activity could encompass a range of consumer focused media, such as:
Digital media—established social network options such as email, FACEBOOK™, TWITTER™, LINKEDIN™, GOOGLE™ marketing, website alerts, banner advertisements, etc, enabling highly effective, low cost, viral marketing.
Television—a higher cost, high reach consumer medium that can prove highly effective if produced and targeted correctly.
Traditional Media—promotions via traditional media outlets such as newspapers, magazines, local radio, national radio, etc.

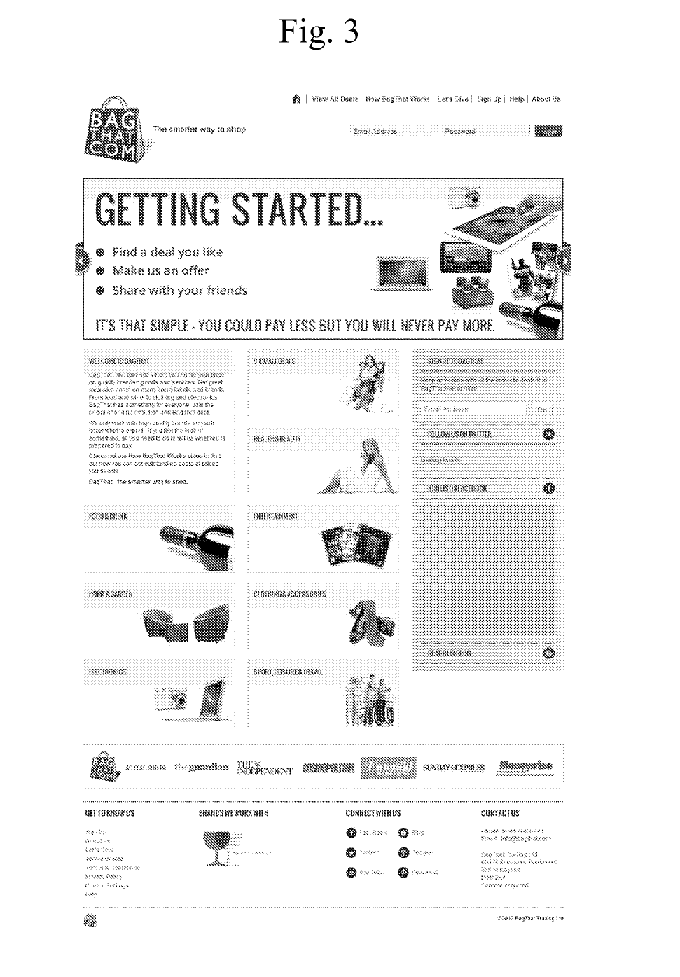

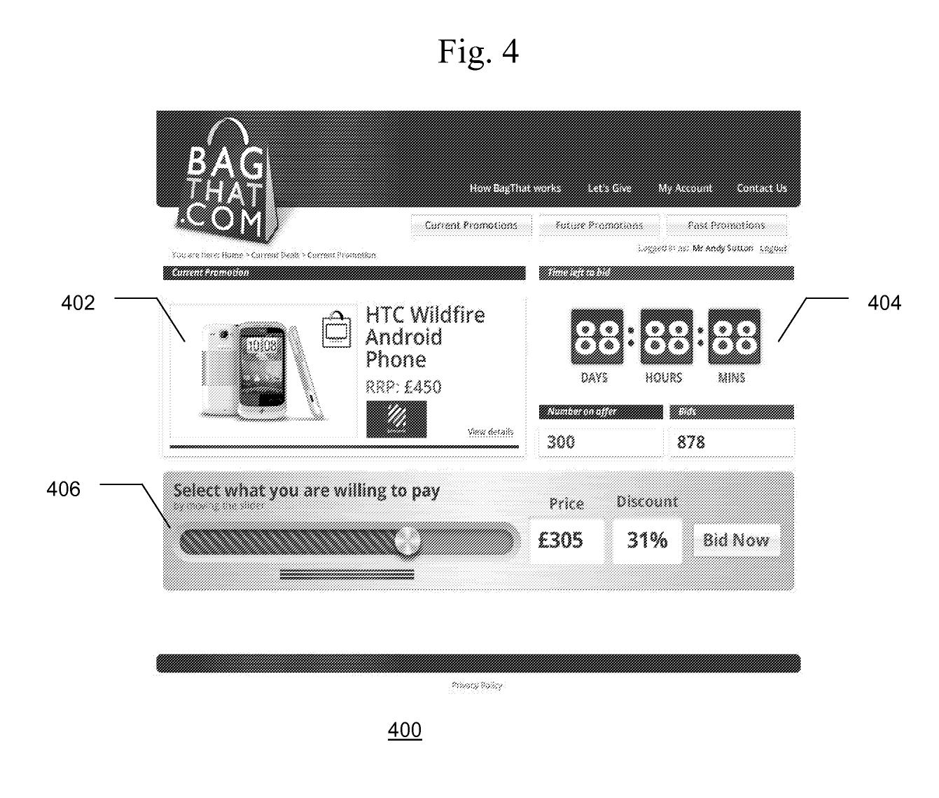

The primary objective of the marketing communications plan is to direct interested consumers to the promotional system operator website via their personal computer, tablet, mobile device or other computing or communication device. Upon arrival at the promotional system operator website the consumer, for example, is greeted with a professional, branded, high quality, dynamic, intuitive, and compelling interactive environment. An example of a home webpage of the promotional system operator website is shown in FIG. 3. On this page, consumers may be presented with a range of promotional offers being promoted through the site. Such promotional offers may be organized by categories, such as those shown in the example of FIG. 3, or the promotional offers may be organized or presented based on other characteristics, such as retail brand, price, recentness of the offer, etc. The presence of high profile brands gives consumers immediate comfort that they are engaging with a reputable site. The home page enables consumers to search for current promotional offers that are available, for future promotions that are planned, and for the outcome of prior promotions. This combination of insights is ultimately aimed at directing the consumer to a live promotion page, such as that shown in FIG. 4.

In step 106, the promotional window is opened and consumer interaction is accepted, using, for example, a live promotion page 400, such as that shown in FIG. 4. The product information displayed and the controls provided to the consumer as shown in FIG. 4 are merely examples. The information displayed and controls provided may vary depending upon the promotion, the product, the promotional system operator, etc. Consumer interaction may be provided using any device having a user interface, such as a computer system, tablet computer, smartphone, etc. Live promotion page 400 may include a number of features, such as product information 402, promotion information 404, and controls 406. Product information 402 may include, for example, images or video of the product, text information about the product, the recommended retail price (RRP), etc. Promotion information 404 may include, for example, how many units are available, how many live bids have been lodged to date and a countdown timer showing how long remains in the current promotion window, etc. Controls 406 provide the capability for the consumer to interact with the page and to indicate how much they are willing to pay for the promotional item. In the example shown in FIG. 4, consumers indicate this information by moving a slider bar. As the slider is moved the changing monetary value is dynamically displayed, along with the respective discount %.

The psychology of the consumer interaction from this point forward is an important component in the success of the promotional system. Many consumers will view the promotional system as an opportunity to acquire goods at price points they would otherwise be unable to afford. For these people, the promotional system allows them to ‘take a punt’ on a price point where there is no downside risk (if they don't get the price they want, they lose nothing). However, most interested people will want to ‘win’ and therefore being able to nudge them towards bidding at the winning price point is vital in securing as many ‘winners’ as possible. Several techniques may be used throughout the promotional window to guide consumers to appropriate price points so as to optimize outcomes for both consumers and suppliers alike.

Once the consumer has confirmed the price they would be prepared to pay, they are asked to confirm their interest by, for example, clicking the ‘Bid Now’ button included in controls 406. Upon confirming their interest, the consumer is transferred to a consumer registration screen where they are asked to enter their personal details such as name, address (billing and shipping), email and contact numbers. Consumers who have previously registered are able to skip this step. Finally, to confirm their bid, the consumer is requested to provide details of their desired payment method (credit card, debit card, PAYPAL™, etc. . . . ) on the understanding that a payment transaction will only be executed at the end of the promotional window if their desired price point or better can be achieved.

Having confirmed a bid, the promotional system may send an email to the consumer confirming details of their bid and its associated terms. The consumer may also be reminded that at any time during the promotional window they can re-enter the site to amend or cancel their bid but at the end of the promotional window, the bid becomes binding.

When consumers confirm their bids with their payment card, it may be desirable to perform a credit check on each consumer and place a hold or “ring-fence” on the funds for the amount of the bid on the consumer's cards until the end of the promotion (or until they cancel their bids). The actual monetary transaction does not occur until the end of the promotion when all winners are defined. For people who don't win, the held amount is similarly released at the end of the promotion. It is possible to complete a transaction at a lower level than the hold by performing a ‘partial capture’ from the card at the point of transaction. This means that consumers never need to lower their bids down to automatically benefit from the best winning price.

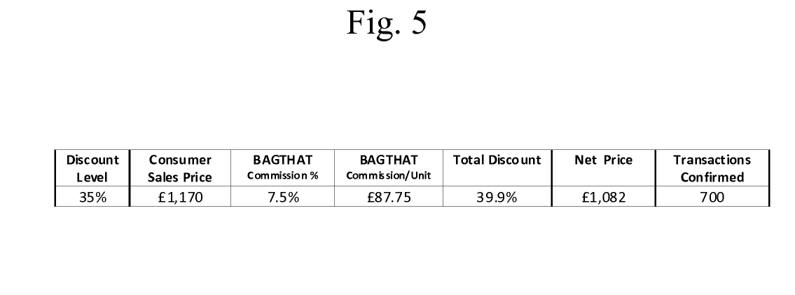

In step 108, the promotional window is closed. In step 110, the promotional system determines the final discount level by, for example, collating information on all confirmed bids and comparing the output to the pre-negotiated volume discount matrix agreed with the supplier. From this, a final discount level is determined based on the numbers of confirmed bids and the prices of those bids, and on the volume discount matrix, as shown, for example, in FIG. 5. For example, a row of the volume discount matrix may be selected by selecting the row that has the greatest discount level from among all rows in which the number of bidders willing to pay an amount greater than or equal to the consumer sales price in that row is greater than or equal to the minimum required volume in that row.

With the final discount level confirmed, it is important to ensure that all ‘winning’ consumers (700 in the example in FIG. 5) benefit from the SAME final price point. This inevitably means that a high percentage of successful consumers will benefit from a price point BELOW that at which they bid. Successful bids are transacted for all consumers who bid an amount greater than or equal to the determined price through their respective payment mechanisms (credit card, debit card, PAYPAL™, etc) and payment is received by the promotional system operator. Suppliers are informed of the winning price point and volume of sales achieved.

Notifications may be sent to all bidding consumers, such as by email. For example, for successful bidders, the email confirms the completed transaction at the final price point, thanks them for their business and notifies them of any INCREMENTAL discount that has been secured. Consumers are also informed that they should expect shipping within a particular timeframe in line with usual supplier arrangements. For unsuccessful bidders, an email is sent apologizing that their requested price point could not be met but informing them of the actual final price point achieved. At this point they may be offered the opportunity to take advantage of the final price point which might appeal to those whose original bid fell just short of that ultimately achieved.

With the suppliers consent, the promotional system website may be updated to show the final consumer price point achieved for the specific promotion. In cases where significant discounts have been achieved, this can be used as banner headlines on the home page. Volumes ordered and the promotional system operator commissions preferably should not be disclosed.

In step 112, the winning transactions are executed and the orders are fulfilled. At this stage the supplier may invoice the promotional system operator for the net sales transaction having deducted the promotional system operator commissions. The promotional system operator may pay the supplier in a B2B transaction and confirm all necessary consumer information to enable shipping. The supplier may ship the product through their normal distribution channel Voucher based promotions may be fulfilled online

The promotional system may include a number of complementary features. For example, the opportunity for the consumer (buyer) to instigate an online dialogue or “Buyerlogue” with the promotional system operator may be provided. With this feature, consumers are able to request products and/or services which they would like to see as future promotions and include the price points that they might be willing to pay for such promotional items. Typically, the consumer requests will be aggregated to gain a consolidated picture of rolling, aggregated demand. This feature will provide the promotional system operator and the suppliers with information on which to target future promotions to consumers with a known need and a target budget.

Many consumers may access the promotional system site but find that the promotions currently available will not match their existing needs. A process of investigation however, might lead certain consumers to explore other offers which the promotional system operator's suppliers may be running within their more traditional online channels. In this scenario, the promotional system may offer consumers a ‘one click’ jump straight into the respective supplier's website and may accept a referral commission from that supplier should the consumer transact on their site within the same visit.

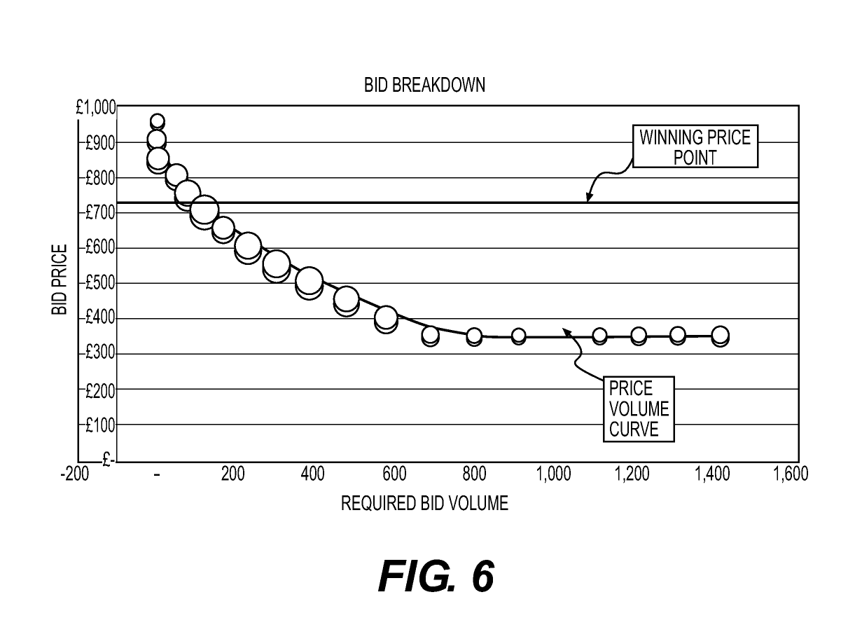

The process of discounted aggregated purchasing will generate a wealth of information related to the buying habits of consumers around particular promotions. Information is captured not only for those consumers who are successful in their bids but importantly, also for those who are not. After each promotion, suppliers will be provided with a promotion analysis report, such as the example shown in FIG. 6. An analysis of this information will enable suppliers to better target future promotions and ensure optimal outcomes.

Moreover, this information may also be available online and in real time during promotions. This feature may be appealing to suppliers as it enables dynamic performance tuning within the live promotion window. Indeed, suppliers are able to monitor the progress of particular promotions in real time and make adjustments on their price volume curve to optimize the outcome for all parties. As an example, if data shows that the promotion has high interest with large volumes of promotions at higher prices than expected, the retailer might decide to release more volume into the promotion or alter the price volume curve upwards. Similarly, if the promotion uptake and bid values are low, the retailer might decide to lower the price volume curve to shift more volume at a lower than anticipated margin. This real time analysis of market data and the ability to react real-time is a significant benefit to suppliers.

In addition, the promotional system may be designed to implement self service capability. With this capability, suppliers will be able to populate their own promotions through their own portals.

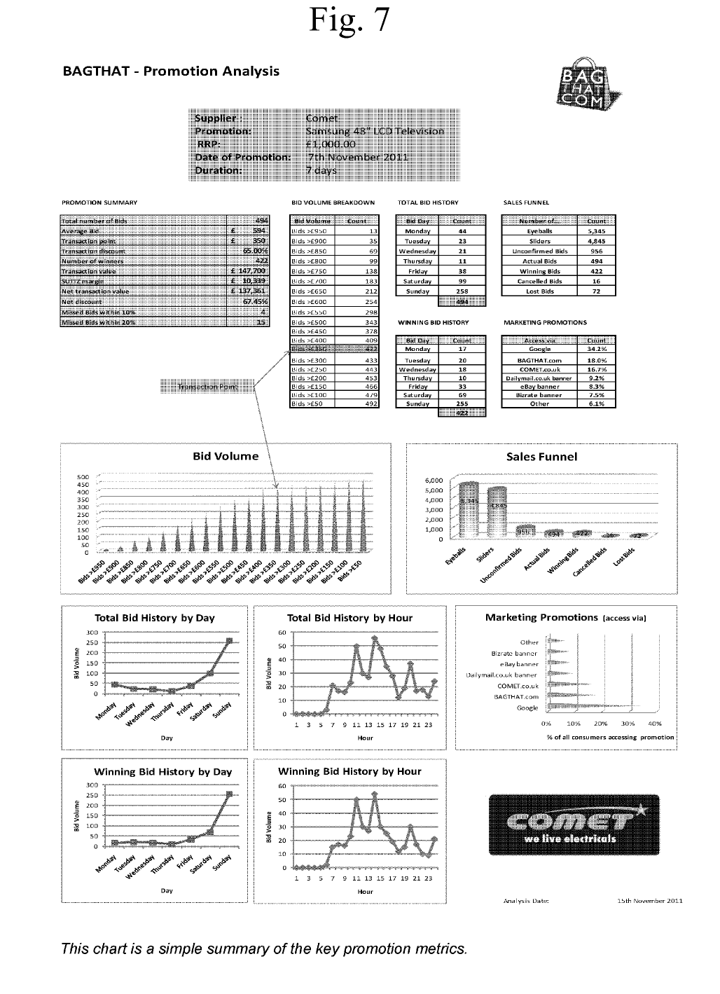

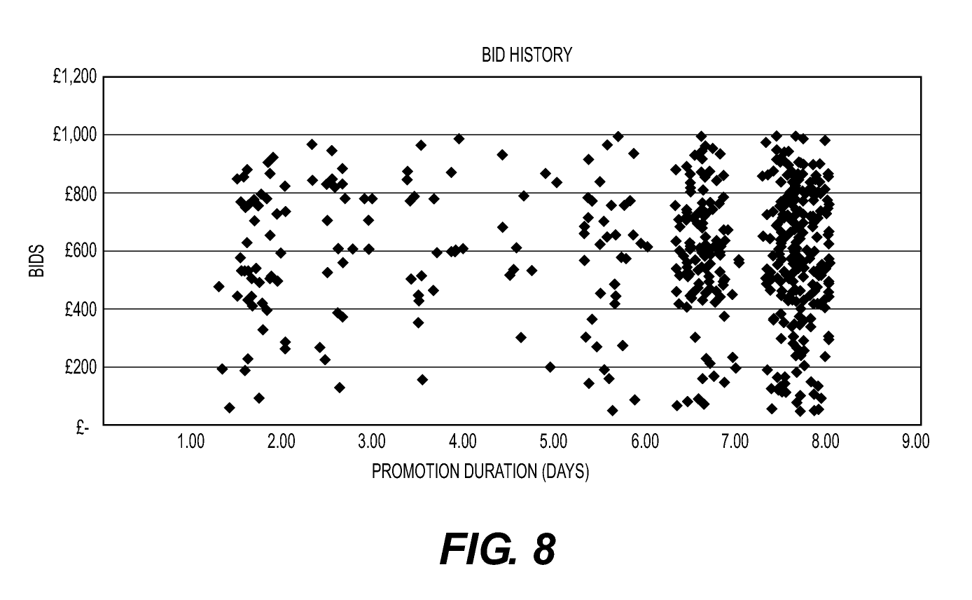

Turning now to FIG. 6, an exemplary promotion analysis report is shown. This example shows volumes of bids in each price category plotted against the price volume curve—the larger the sphere the larger the number of bids in that bid range. This allows suppliers to see their missed potential opportunity and adjust their price volume curve accordingly. In FIG. 7, an example of a summary of the key promotion metrics is shown. In FIG. 8, an example of a chart showing a time log of when bids were made during the promotion and at what level. This information provides insights into the optimal times to launch promotions and optimal periods for promotions to run.

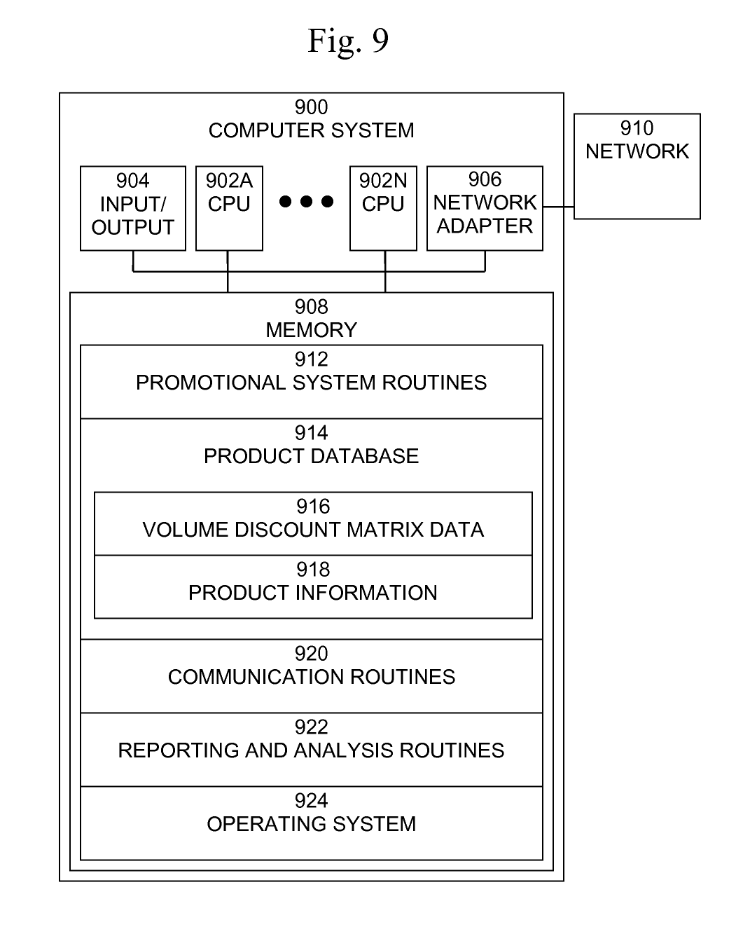

An exemplary block diagram of a computer system 900, in which a promotional system may be implemented, is shown in FIG. 9. System 900 is typically a programmed general-purpose computer system, such as a personal computer, workstation, server system, or minicomputer or mainframe computer. System 900 may include one or more processors (CPUs) 902A-902N, input/output circuitry 904, network adapter 906, and memory 908. CPUs 902A-902N execute program instructions in order to carry out the functions of the present invention. Typically, CPUs 902A-902N are one or more microprocessors, such as an INTEL PENTIUM® processor. FIG. 9 illustrates an embodiment in which System 900 is implemented as a single multi-processor computer system, in which multiple processors 902A-902N share system resources, such as memory 908, input/output circuitry 904, and network adapter 906. However, the present invention also contemplates embodiments in which system 900 is implemented as a plurality of networked computer systems, which may be single-processor computer systems, multi-processor computer systems, or a mix thereof. The computer system or systems may be at one or more physical locations. Typical examples of physical locations may include premises of the promotional system operator, a single or multiple local or remote “server farms”, at a plurality of distributed locations, or in the cloud. Such computer systems may be provided and operated by the promotional system operator, or they may be provided and operated by a computing service vendor. One such example is cloud computing, which is the use of computing resources, such as hardware and software, that are delivered as a service over a network, such as the Internet, or other public or private network. Examples of typical cloud computing services include Infrastructure as a service (IaaS), Platform as a service (PaaS), Software as a service (SaaS), and Storage as a service (STaaS). The present invention contemplates any physical location of computer systems and networks, as well as any physical or logical provision, operation, or implementation of computer systems and networks.

Input/output circuitry 904 provides the capability to input data to, or output data from, database/system 900. For example, input/output circuitry may include input devices, such as keyboards, mice, touchpads, trackballs, scanners, etc., output devices, such as video adapters, monitors, printers, etc., and input/output devices, such as, modems, etc. Network adapter 906 interfaces device 900 with network 910. Network 910 may be any standard local-area or wide-area communications or tele-communications network, whether wired or wireless, or public, private, or proprietary. Typically network 910 may include the Internet, along with one or more other networks.

Memory 908 stores program instructions that are executed by, and data that are used and processed by, CPU 902 to perform the functions of system 900. Memory 908 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE), Serial ATA (SATA) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 908 vary depending upon the function that system 900 is programmed to perform. In the example shown in FIG. 9, memory 908 may include promotional system routines 912, product database 914, which may include volume discount matrix data 916, and product information 918, communication routines 920, reporting and analysis routines 922, and operating system 924. Promotional system routines 912 include software implementing the functionality of the promotional system, such as software for providing consumer interaction by displaying product information and accepting input, and for providing supplier interaction. Product database 914 may include volume discount matrix data 916, and product data 918. Volume discount matrix data 916 may include data defining a volume discount matrix that has been negotiated with the supplier determining the levels of discount that are available depending upon final volume of sales achieved. Product information 918 may include, for example, images or video of the product, text information about the product, the recommended retail price (RRP), etc. Communication routines 920 provide the capability to communicate with consumers and suppliers, such as by email. Reporting and analysis routines provide the capability to analyze promotional data and generate reports regarding promotions, such as those shown in FIGS. 6-8. Operating system 924 provides overall system functionality.

As shown in FIG. 9, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a non-transitory computer readable medium of instructions and a variety of other forms and that the present invention applies equally regardless of the particular type of media actually used to carry out the distribution. Examples of non-transitory computer readable media include, but are not limited to, floppy disks, hard disk drives, CD-ROMs, DVDROMs, ROM, and flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for promotional discounted aggregated purchasing performed in a computer system comprising a processor and a memory storing software code, executable by the processor, and data, accessible by the processor, for performing the method comprising:
determining a volume discount matrix for a product to be available during a promotional period;
accepting bids from a plurality of consumers indicating a price each consumer is willing to pay for the product;
placing a hold on payment cards of the consumers who have entered bids, each hold being for the amount of each bid;
at a conclusion of the promotional period, determining a price for the product based on a final discount level that is determined based on the received bids and on the determined volume discount matrix; and
performing transactions for the product for all consumers who bid an amount greater than or equal to the determined price.

2. The method of claim 1, wherein the volume discount matrix comprises information indicating a minimum volume of the product that must be purchased in order to obtain a corresponding discount level.

3. The method of claim 1, further comprising:
accepting the bids from the consumers without revealing information related to the volume discount matrix to the consumers.

4. The method of claim 1, further comprising:
accepting input from consumers relating to products and/or services which the consumers would like to see as future promotions and relating to prices the consumers are willing to pay; and
aggregating the input from the consumers to determine recommendations for future promotions.

5. The method of claim 1, further comprising:
analyzing information relating to the promotional discounted aggregated purchasing in real-time to generate promotion metrics.

6. A computer program product for promotional discounted aggregated purchasing comprising a non-transitory computer readable medium having recorded thereon computer program instructions, the computer program instructions executable by at least one processor to perform:
determining a volume discount matrix for a product to be available during a promotional period;
accepting bids from a plurality of consumers indicating a price each consumer is willing to pay for the product;
placing a hold on payment cards of the consumers who have entered bids, each hold being for the amount of each bid;
at a conclusion of the promotional period, determining a price for the product based on a final discount level that is determined based on the received bids and on the determined volume discount matrix; and
performing transactions for the product for all consumers who bid an amount greater than or equal to the determined price.

7. The computer program product of claim 6, wherein the volume discount matrix comprises information indicating a minimum volume of the product that must be purchased in order to obtain a corresponding discount level.

8. The computer program product of claim 6, further comprising:
accepting the bids from the consumers without revealing information related to the volume discount matrix to the consumers.

9. The computer program product of claim 6, further comprising:
accepting input from consumers relating to products and/or services which the consumers would like to see as future promotions and relating to prices the consumers are willing to pay; and
aggregating the input from the consumers to determine recommendations for future promotions.

10. The computer program product of claim 6, further comprising:
analyzing information relating to the promotional discounted aggregated purchasing in real-time to generate promotion metrics.

11. A system for promotional discounted aggregated purchasing comprising a processor operable to execute computer program instructions, a memory operable to store computer program instructions executable by the processor, and computer program instructions stored in the memory and executable to perform:
determining a volume discount matrix for a product to be available during a promotional period;
accepting bids from a plurality of consumers indicating a price each consumer is willing to pay for the product;
placing a hold on payment cards of the consumers who have entered bids, each hold being for the amount of each bid;
at a conclusion of the promotional period, determining a price for the product based on a final discount level that is determined based on the received bids and on the determined volume discount matrix; and
performing transactions for the product for all consumers who bid an amount greater than or equal to the determined price.

12. The system of claim 11, wherein the volume discount matrix comprises information indicating a minimum volume of the product that must be purchased in order to obtain a corresponding discount level.

13. The system of claim 11, wherein the computer program instructions are further executable to perform:
accepting the bids from the consumers without revealing information related to the volume discount matrix to the consumers.

14. The system of claim 11, wherein the computer program instructions are further executable to perform:
accepting input from consumers relating to products and/or services which the consumers would like to see as future promotions and relating to prices the consumers are willing to pay; and
aggregating the input from the consumers to determine recommendations for future promotions.

15. The system of claim 11, wherein the computer program instructions are further executable to perform:
analyzing information relating to the promotional discounted aggregated purchasing in real-time to generate promotion metrics.
